(19) United States
(12) Patent Application Publication
(10) Pub. No.: US 2026/0194922 A1
(43) Pub. Date: Jul. 9, 2026

(54) USING INDEPENDENT AUTONOMOUS ROBOTS TO FORM A SNAKE ROBOT

(71) Applicant: International Business Machines Corporation, Armonk, NY (US)

(72) Inventors: Anita Duggal, Delhi (IN); Mukundan Sundararajan, Bangalore (IN); Sarbajit Kumar Rakshit, Kolkata (IN)

(21) Appl. No.: 19/009,766

(22) Filed: Jan. 3, 2025

(51) Int. Cl. G05D 1/695; G05D 1/698

(52) U.S. Cl. CPC G05D 1/696; G05D 1/6985

(57) ABSTRACT

A method, according to one embodiment, includes determining a task to complete, where the task includes a mobility subtask and an activity subtask. The method further includes determining a plurality of independent autonomous robots to use to complete the task, and causing the independent autonomous robots to couple together to form a snake robot. The method further includes causing a first of the independent autonomous robots to instruct a remainder of the independent autonomous robots during completion of the mobility subtask, and causing a second of the independent autonomous robots to decouple from the snake robot to perform a first portion of the activity subtask. In response to a determination that the first portion of the activity subtask has been completed by the second independent autonomous robot, the second independent autonomous robot is caused to recouple with the snake robot in a determined location of the snake robot.

### BACKGROUND

The present invention relates to robots, and more specifically, this invention relates to collaboration between different robots.

Robots are typically electrically powered machines that perform programmable tasks without human intervention. For example, in some use cases, robots are fixedly positioned on an assembly line and produce products such as automobiles. In some other use cases, robots are battery powered and configured to navigate over a geographical area.

### SUMMARY

A method, according to one embodiment, includes determining a task to complete, where the task includes a mobility subtask and an activity subtask. The method further includes determining, based on the determined task, a plurality of independent autonomous robots to use to complete the task, and causing the independent autonomous robots to couple together to form a snake robot. The coupling of the independent autonomous robots is established using selectively engaging coupling components of the independent autonomous robots. The method further includes causing a first of the independent autonomous robots in a head position of the snake robot to instruct a remainder of the independent autonomous robots during completion of the mobility subtask, and causing a second of the independent autonomous robots to decouple from the snake robot to perform at least a first portion of the activity subtask. In response to a determination that the first portion of the activity subtask has been completed by the second independent autonomous robot, the second independent autonomous robot is caused to recouple with the snake robot in a determined location of the snake robot.

A computer program product, according to another embodiment, includes one or more computer readable storage media, and program instructions stored on the one or more storage media to perform the foregoing method.

A computer system, according to another embodiment, includes a processor set, one or more computer readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIGS. 3A-3E depict an overview of a collection of independent autonomous robots, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using independent autonomous robots to form a snake robot.

In one general embodiment, a method includes determining a task to complete, where the task includes a mobility subtask and an activity subtask. The method further includes determining, based on the determined task, a plurality of independent autonomous robots to use to complete the task, and causing the independent autonomous robots to couple together to form a snake robot. The coupling of the independent autonomous robots is established using selectively engaging coupling components of the independent autonomous robots. The method further includes causing a first of the independent autonomous robots in a head position of the snake robot to instruct a remainder of the independent autonomous robots during completion of the mobility subtask, and causing a second of the independent autonomous robots to decouple from the snake robot to perform at least a first portion of the activity subtask. In response to a determination that the first portion of the activity subtask has been completed by the second independent autonomous robot, the second independent autonomous robot is caused to recouple with the snake robot in a determined location of the snake robot.

In another general embodiment, a computer program product includes one or more computer readable storage media, and program instructions stored on the one or more storage media to perform the foregoing method.

In another general embodiment, a computer system includes a processor set, one or more computer readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as independent autonomous robot determination and control code of block 150 for using independent autonomous robots to form a snake robot. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

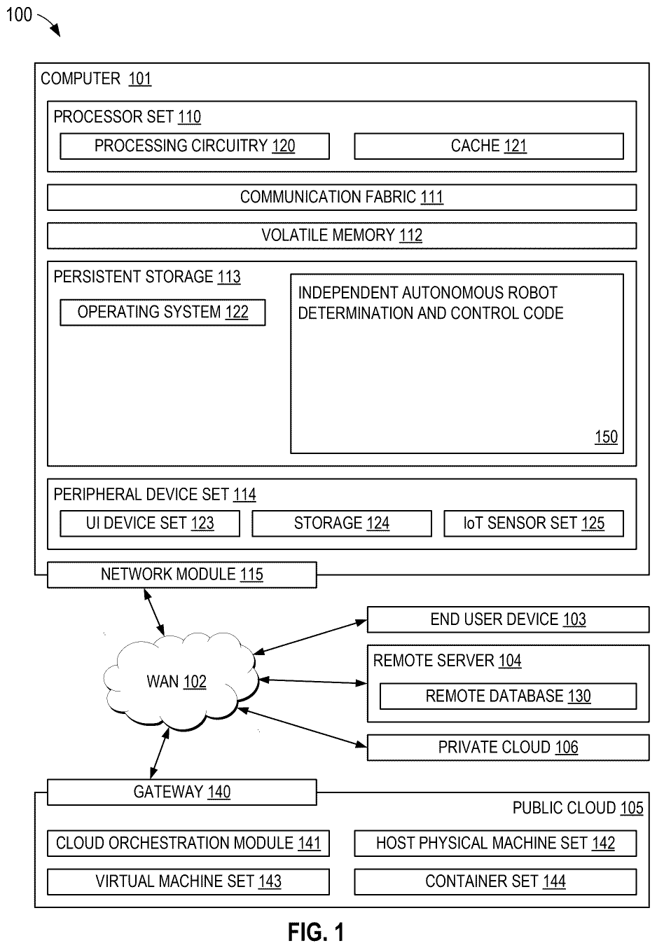

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

### Persistent Storage 113 Is Any Form of Non-volatile Storage for

computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, robots are typically electrically powered machines that perform programmable tasks without human intervention. For example, in some use cases, robots are fixedly positioned on an assembly line and produce products such as automobiles. In some other use cases, robots are battery powered and configured to navigate over a geographical area.

One type of robot is a snake robots, which is a linear single robot that navigates using snake-like behaviors. Snake robots face operational issues in that relatively longer snake robots face difficulties in maintaining control accuracy, avoiding mechanical interference, and ensuring reliable communication along the mechanical structure of the snake robot. The actual minimum and maximum lengths of snake robots can vary based on technological advancements, design innovations, and the specific applications the snake robots are intended for. However, as the length of the snake robot increases, the complexity of the control system of the snake robot and the challenges related to power distribution as well as communication also increase.

These issues that conventional robots face are further complicated by the fact that relatively smaller robots often are prone with limitations in terms of their available mobility types and speeds. While smaller dimensions of robots are often suitable for specific tasks, conventional relatively smaller robots are not effective in all use cases. For example, some scenarios include a specialized cutting robot or special relatively small robot based equipment that needs to reach a location moving through a tubular space or over a relatively low load points. However, the equipment and construction of a robot may not allow the robot to do so based on fixed dimensions of the robot. Furthermore, in another example, a set of robots may need to move from one manufacturing cell to another, however, at least some of the robots may not have all the sensors needed to track, guide and control their movement during the move.

In sharp contrast to the deficiencies of the conventional approaches described above, the techniques of embodiments and approaches described herein include using a plurality of independent autonomous robots to complete a task that includes a mobility subtask and an activity subtask. The independent autonomous robots are selectively arranged to form a snake robot where each segment of the snake robot comprises an independent autonomous robot, interlinked for snake-like movement. The independent autonomous robots transition to a snake robot computation mode when coupled together, while, when decoupled, the independent autonomous robots have processing circuits to operate independently. These techniques, in some approaches, adjust deployment based on activity and robot needs. The independent autonomous robots may be the same size and/or different sizes, where relatively smaller robots with their own mobility, e.g., wheels, legs, tracks, etc., can form snake structures as needed. Historical data may, in some approaches, be used to guide snake size determinations. Furthermore, a coupling module may equip each independent autonomous robot for versatile snake-like motion, while the independent autonomous robots may be caused to shift modes based on determined context(s) and need(s). Dynamically activated coupling empowers the snake movement, while in contrast, one or more of the independent autonomous robots may be decoupled for diverse reasons, e.g., damage, capacity analysis, etc. In other words, configurations of the independent autonomous robots are adaptable for various activities.

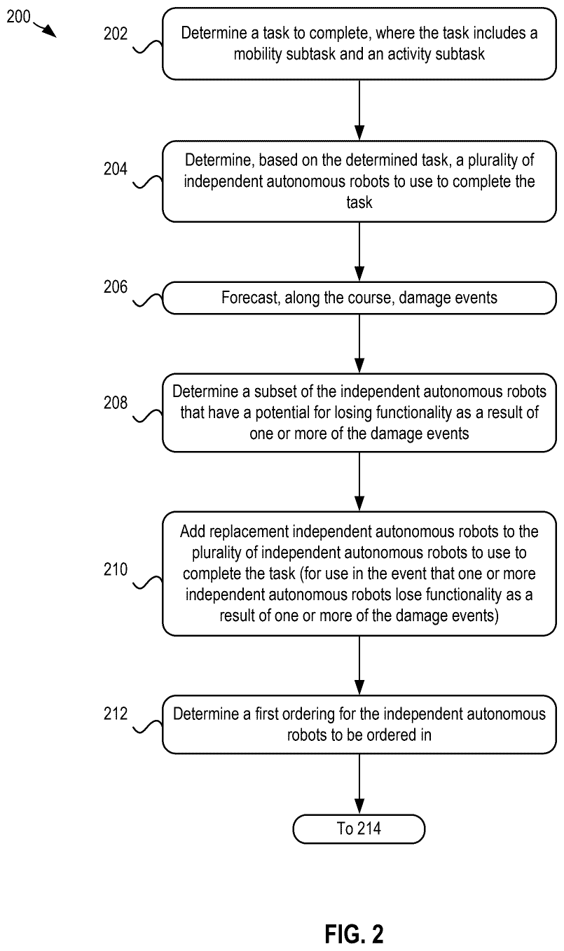

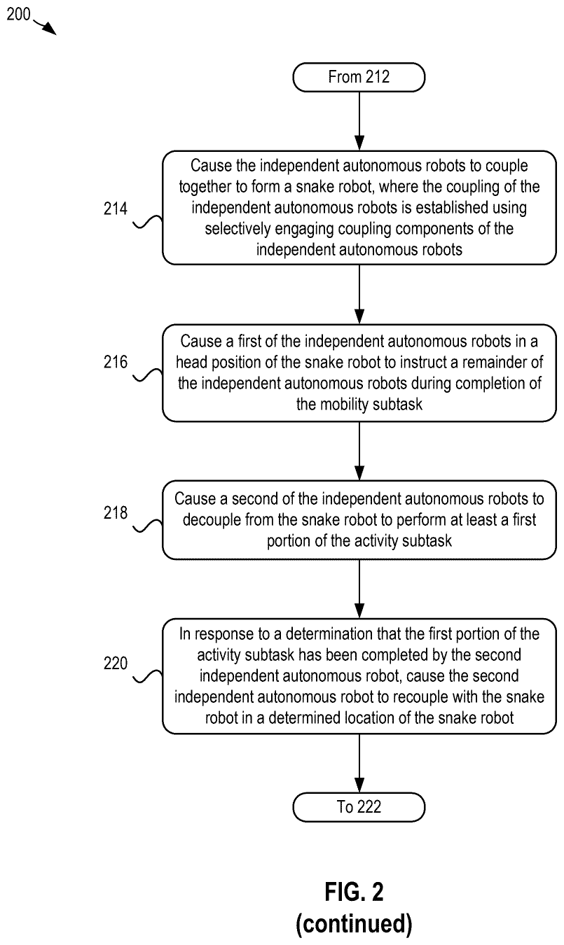

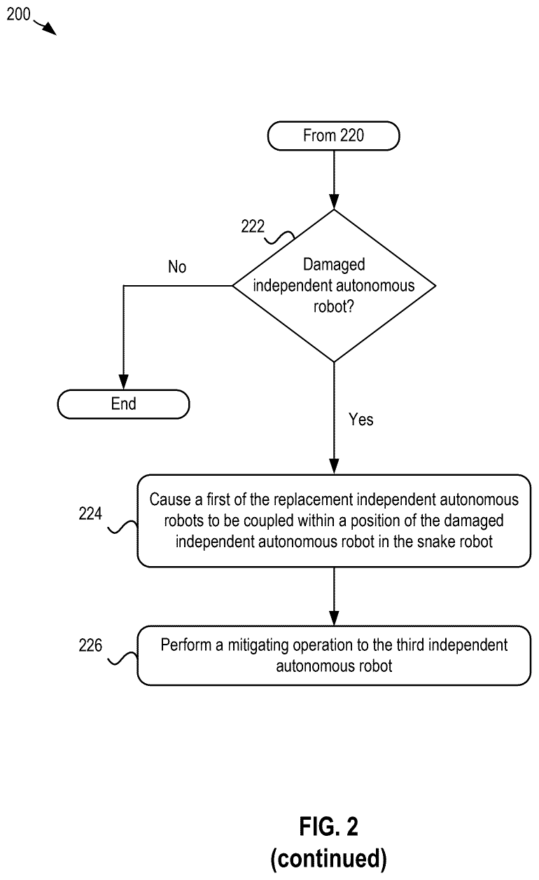

Now referring to FIG. 2, a flowchart of a method 200 is shown according to one embodiment. The method 200 may be performed in accordance with aspects of the present invention in any of the environments depicted in FIGS. 1-3E, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes determining a task to complete. For context, the task may be defined as a mission that is to be accomplished using robots. In some approaches, one or more tasks are determined in response to a predetermined event occurring, e.g., a disaster event, an order for a product being placed, a request being received to survey a geographical area, etc.

In some approaches the task may include a mobility subtask and an activity subtask. The mobility subtask may be defined as a portion of the task that involves performing physical activities, e.g., navigating a geographical area, potentially in order to reach one or more areas that the activity subtasks are to be performed. The mobility subtask may, in some approaches, include climbing a structure, swimming across a body of water, navigating through and/or around a terrain obstacle, propelling from a first location to a second location, etc. Meanwhile, the activity subtask may, in some approaches, include activities that are to be performed (by one or more independent autonomous robots) at one or more areas that are navigated to. According to some approaches, the activity subtask may include one or more of, e.g., scanning an environment, recovering an object, carrying the object, delivering a payload, etc.

In some approaches, in order to identify the task, a course that over one or more independent autonomous robots will travel is identified. For example, in order to perform an activity subtask at different areas, e.g., such as delivery payloads to a plurality of locations, one or more navigational paths between the locations may be determined. Types of mobility that navigating these navigational paths may include, e.g., swimming, crawling, wheeling, etc., may be determined using techniques that would become apparent to one of ordinary skill in the art after reading the descriptions herein. For example, a trained artificial intelligence (AI) engine may be caused, e.g., instructed to analyze historical records and/or information on the web to determine the types of mobility. In some approaches, the AI engine is caused to monitor a training set of data that is based on snake movement to learn mobility capabilities for the independent autonomous robots to perform one coupled together.

In another example, techniques for determining the task may include performing an IoT image analysis on the surrounding of an activity of a request that is received, where the request defines, at least a portion of, an activity scope that is to be accomplished using independent autonomous robots.

Based on the determined task, a plurality of independent autonomous robots to use to complete the task are determined, e.g., see operation 204. In some approaches, the plurality of independent autonomous robots are determined from a pool of independent autonomous robots. In order to determine the independent autonomous robots to use to complete the task, in some approaches, specifications for the independent autonomous robots of the pool may be identified. This way, a collection of independent autonomous robots that fit the requirements of performing the task may be determined and coupled together (like ribs) to form a snake robot.

In some approaches, the independent autonomous robots are selected to use to complete the task, or attentively, filtered out from selection, based on capabilities of the independent autonomous robots. The determining, based on the determined task, the plurality of independent autonomous robots to use to complete the task, in some approaches, comprises identifying, over a course on which the mobility subtask is to be performed, types of mobile components that are needed to traverse the course, where the plurality of independent autonomous robots are determined based on the independent autonomous robots having the identified types of mobile components. For example, in some approaches, capabilities of the independent autonomous robots may be considered with respect to, e.g., abilities to identify obstacles, abilities to navigate terrain types, abilities to overcome potential hazards, any specific challenges that could affect robot mobility, a battery potential with respect to a determined destination, etc. Types of mobility that at least some of the independent autonomous robots may be configured to and/or need, in some approaches, include, wheeled mobility which may be suitable for flat and even terrain surfaces. The types of mobility that at least some of the independent autonomous robots may be configured to and/or need, in some approaches, additionally and/or alternatively include tracked mobility (one or more guided tracks) which may be relatively effective for rough or uneven terrain. The types of mobility that at least some of the independent autonomous robots may be configured to and/or need, in some approaches, additionally and/or alternatively include legged mobility which may be relatively useful for navigating complex and/or unstructured environments. Aerial mobility is another types of mobility, where aerial mobility may be relatively ideal for covering large areas or navigating obstacles from an aerial perspective. Swimming mobility is a capability of independent autonomous robots that may be particularly useful for navigating throughout water-based environments. Furthermore, climbing mobility is a capability of independent autonomous robots that may be particularly useful for navigating vertical surfaces and/or structures.

In some approaches, the techniques described herein include performing a mobility assessment of each individual independent autonomous robot, during which the mobility capabilities of the independent autonomous robots are evaluated against the identified mobility types. A determination is made as to whether the independent autonomous robots are equipped with the necessary mechanisms (wheels, tracks, legs, propellers, etc.) for the required types of mobility, and in response to a determination that the identified mobility types of the individual independent autonomous robots are not sufficient to reach the destination or perform required tasks, the gaps may be evaluated. A determination is made as to which mobility types are missing and are necessary to overcome the challenges in the environment associated with performance of the task, which will be identified based on the specification of the individual (rib) independent autonomous robots of the snake robot that the independent autonomous robots form. In such approaches, based on the identified gap in the mobility capability, the techniques described herein identify which types of gaps are to be covered so that the mobility can be achieved.

With continued reference to the functional capabilities of the independent autonomous robots that are considered for competing the task and/or ultimately selected to use to complete the task, in some preferred approaches, a plurality of, and preferably all of, the independent autonomous robots are configured to operate independently based on the independent autonomous robots including their own independent hardware components. For example, such hardware components may, in some approaches, include, e.g., an individual battery component or power source, sensors, actuators, a control system, processing circuits, mobile components, selectively engaging coupling components, etc. The mobile components may, in some approaches, include, e.g., wheels, tracks, legs, water propulsion components, low gravity propulsion components, propellers, fingers, friction components, etc. Furthermore, the selectively engaging coupling components may, in some approaches, allow each of the independent autonomous robots to be selectively coupled with at least one other independent autonomous robot, and in preferred approaches, two or more independent autonomous robots. The selectively engaging coupling components may be of a type of coupling component that would become apparent to one of ordinary skill in the art after reading the descriptions herein, e.g., magnets, latches, hooks, glue, hook and loop tape, pins, hitches, etc. The selectively engaging coupling components may, in some approaches, have multi-degree freedom of movement capabilities with attachment and detachment capabilities, and while coupled establishment of a stable communication connection. Materials that the independent hardware components are composed of may, in some approaches, include relatively lightweight materials, such as carbon fiber, to keep the overall weight of the independent autonomous robots and/or the snake robot within a predetermined range of weight.

As will now be described below, in some approaches, additional (reserve) independent autonomous robots may be selected and included in the plurality of independent autonomous robots to use to complete the task. For example, operation 206 includes forecasting, along the course, damage events. Damage events may be defined as events that are forecasted to occur (greater than a predetermined threshold degree of expectancy) that have a potential for damaging the structural integrity and/or internal hardware operability and/or software performance of one or more of the independent autonomous robots. For example, these damage events may include, e.g., earthquakes, collapse of a structure (such as a building), extreme temperatures (that fall outside an operating temperature range of hardware of the independent autonomous robots), etc. A subset of the independent autonomous robots that have a potential for losing functionality as a result of one or more of the damage events may be determined, e.g., see operation 208. The subset of the independent autonomous robots establish independent autonomous robots that are vulnerable to the damage events. In order to plan for these damage events, determining, based on the determined task, the plurality of independent autonomous robots to use to complete the task may, in some approaches, comprise adding replacement independent autonomous robots for replacing the subset of the independent autonomous robots that have a potential for losing functionality as a result of one or more of the damage events, e.g., see operation 210. As will be described in further detail elsewhere below, these replacement independent autonomous robots may be reserved for use in the event that one or more independent autonomous robots lose functionality as a result of one or more of the damage events.

The number of independent autonomous robots that are determined and selected for the plurality of independent autonomous robots to use to complete the task may, in some approaches, be based on constraints to a length of a snake robot that is formed by coupling the independent autonomous robots together. For example, in some approaches, a minimum and maximum length of the snake robot can vary depending on its design, intended purpose, and the specific engineering constraints of its construction. There is no fixed standard for these dimensions, however, the length of the independent autonomous robots that can be coupled together may, in some approaches, be based on one or more factors that may be considered. A first of these factors is a minimum length of the snake robot. The minimum length of a snake robot segment may be determined by factors such as the size of the independent autonomous robots or components thereof, the complexity of control systems, and the practicality of movement. The snake robot may, in some approaches, be designed for relatively confined spaces or microscale applications based on having a limited number of independent autonomous robots and/or independent autonomous robots that are merely a few centimeters long. Another factor includes a maximum length of the snake robot. The maximum length of the snake robot may be influenced by and therefore determined by using factors such as the structural integrity of the independent autonomous robots or components thereof, a complexity of control algorithms, and the challenges in maintaining stability and coordination over a relatively longer snake robot body. In some approaches, the independent autonomous robots may be selected for designing a snake designed for specific tasks. For example, for a task that includes an exploration and/or search and rescue-based mobility subtask and an activity subtask, a snake robot may be designed to have relatively longer lengths, potentially ranging from several meters to tens of meters.

Operation 212 includes determining a first ordering for the independent autonomous robots to be ordered in. For example, the first ordering may include the first independent autonomous robot in a head position of the snake robot while a remainder of the independent autonomous robots trail from the head of the snake robot to a tail position (end) of the snake robot. In some approaches, the first ordering is based on a first obstacle that the snake robot is predicted to encounter while traversing the course. For example, in some approaches, the independent autonomous robots that are used to initially traverse over the obstacle may be positioned at a front portion of the snake robot within the first ordering.

In some approaches, the first ordering for the independent autonomous robots may be a randomly determined ordering, e.g., using a random order generator.

In some approaches, in order to enable lateral undulation which mimics the side-to-side wavelike motion of a real snake, the first ordering may include an even distribution of independent autonomous robots that are configured to push against surfaces or obstacles (to create friction and move forward) along the body of the snake robot, e.g., every other independent autonomous robot along the snake robot. In some other approaches, in order to enable rectilinear motion (where the snake robot moves in a straight line by using a combination of pushing and pulling against surfaces), independent autonomous robot that are configured to alternate the expansion and contraction of their structural frame may be distributed along the body of the snake robot. Sidewinding-type motion may additionally and/or alternatively be enabled for the snake robot by selecting independent autonomous robots configured to move across sandy or loose surfaces, e.g., independent autonomous robots couple and distributed in a line down the snake robot to create a series of anchor points and lifting other independent autonomous robots off the ground in a wave-like pattern.

In some other approaches, in order to enable concertina locomotion, independent autonomous robots that are configured to be anchored anchor while extending and anchoring other independent autonomous robots be selected to enable the snake robot to be pushed and/or pulled through confined spaces. In order to enable climbing of various structures, such as pipes, trees, and poles, at least some of the independent autonomous robots may have flexible components and/or bodies that are configured to wrap around objects and move the snake robot upwards. One or more of the independent autonomous robots may be designed for underwater environments by together or in part being configured to use lateral undulation or serpentine motion to swim efficiently. At least some of the independent autonomous robots may be selected based on the independent autonomous robots including burrowing components. In applications in which the task includes search and rescue and/or exploration, these independent autonomous robots may enable the snake robot to burrow into confined spaces, rubble, or soil, using their segmented bodies to navigate and create paths. In order to burrow, in some approaches, the independent autonomous robots that include burrowing components may be positioned at the head or tail of the robot, while in some other approaches, the independent autonomous robots that include burrowing components may be decoupled from the snake robot to perform burrowing activity subtasks.

In some other approaches, in order to enable aerial motion, at least some of the independent autonomous robots may include drone components to allow the segmented components of the snake robot to move in a snake-like manner through the air. In yet some other approaches, in order to enable amphibious motion (transition between land and water), at least some of the independent autonomous robots may be selected based on having flexible bodies to enable the snake robot or portions thereof to move effectively in both environments.

Operation 214 includes causing, e.g., instructing, the independent autonomous robots to couple together to form a snake robot, where the coupling of the independent autonomous robots is established using selectively engaging coupling components of the independent autonomous robots. More specifically, in some preferred approaches, the independent autonomous robots are instructed to couple together according to the first determined ordering to form a snake robot.

In some approaches, method 200 includes causing, e.g., instructing, a first of the independent autonomous robots in a head position of the snake robot to instruct a remainder of the independent autonomous robots during completion of the mobility subtask, e.g., see operation 216. For example, the first independent autonomous robot may be positioned to view and scan a navigational path for the snake robot along the course on which the mobility subtask is being performed. Based on this, the first independent autonomous robot may be instructed to compute a workload for completing the mobility subtask. In some approaches, the workload includes instructing one or more of the independent autonomous robots to decouple from the snake robot in order to perform at least a portion of the activity subtask. Accordingly, in some approaches, method 200 includes causing, e.g., instructing, a second of the independent autonomous robots to decouple from the snake robot to perform at least a first portion of the activity subtask, e.g., see operation 218.

More than one of the independent autonomous robots may be concurrently decoupled from the snake robot, in some approaches. For example, method 200, in some approaches, includes causing, e.g., instructing, a third of the independent autonomous robots (of the remainder of the independent autonomous robots) to decouple from the snake robot to perform at least a second portion of the activity subtask. The third independent autonomous robots may be caused and/or configured to control itself during the period of the decoupling while performing at least the portion of the activity subtask. More specifically, in one or more of such approaches, the second independent autonomous robot and the third independent autonomous robot are concurrently decoupled from the snake robot during performance of the respective portions of the activity subtask.

It should be noted that the second independent autonomous robot controls itself during the period in which the second independent autonomous robot is not coupled with the snake robot and while performing at least the first portion of the activity subtask. Furthermore, for context, in some approaches, at least some of the independent autonomous robots that are not preparing to perform and/or actively performing at least a portion of the activity subtask remain coupled to other independent autonomous robots, e.g., a break in the independent autonomous robots, may be filled with the independent autonomous robots that remain coupled with other independent autonomous robots.

In response to a determination that the first portion of the activity subtask has been completed by the second independent autonomous robot, method 200 may include causing the second independent autonomous robot to recouple with the snake robot in a determined location of the snake robot, e.g., see operation 220. In some approaches, the determination that the first portion of the activity subtask has been completed by the second independent autonomous robot is based on the second independent autonomous robot outputting confirmation that the first portion of the activity subtask is completed, which may be received by a processing circuit performing method 200. In some other approaches, the determination that the first portion of the activity subtask has been completed by the second independent autonomous robot is based on one of the other independent autonomous robots detecting that the first portion of the activity subtask is completed, e.g., based on observing the second independent autonomous robot during performance of the first portion of the activity subtask.

As mentioned elsewhere above, in some approaches, an ordering of the independent autonomous robots may be determined, and the independent autonomous robots may be caused to be coupled in the determined ordering. For example, the first ordering is based on a first obstacle that the snake robot is predicted to encounter while traversing the course. In such an approach, in response to a determination that the snake robot has traversed the first obstacle, method 200 includes determining and reordering the independent autonomous robots in a second ordering. In some approaches, the second ordering for the independent autonomous robots is based on a second obstacle that the snake robot is predicted to encounter while traversing the course (where the second obstacle is a different type of obstacle than the first obstacle).

With continued reference to approaches detailing reordering and recoupling of the independent autonomous robots, in some approaches, method 200 includes determining the location for the second independent autonomous robot to recouple with the snake robot. The determining the location, in some approaches, includes forecasting whether the mobile components of the second independent autonomous robot are needed for completing a remaining uncompleted portion of the mobility subtask. Forecasting techniques of a type that would become apparent to one of ordinary skill in the art after reading the descriptions herein may be used. In response to a determination that the mobile components of the second independent autonomous robot are forecasted to be needed for completing the remaining uncompleted portion of the mobility subtask, method 200 may include determining and causing the second independent autonomous robot to be placed in a location within the snake robot that allows the mobile components of the second independent autonomous robot to be used for completing the remaining uncompleted portion of the mobility subtask.

Independent autonomous robot(s) may become damaged in any point during performance of the task. Accordingly, in some approaches, method 200 includes determining whether an independent autonomous robot has been damaged during the damage events, e.g., see decision 222. One or more independent autonomous robots may be determined to have been damaged during the damage events based on predetermined conditions being met, e.g., a loss of communication with the independent autonomous robot, receiving a report of the damage by the damaged independent autonomous robot, receiving a report of the damage by another independent autonomous robot, etc.

In response to a determination that none of the independent autonomous robots have been damaged, the snake robot may be caused to return to a location that the snake robot originally departed from (provided that a determination is made that the activity subtask has been completed. Thereafter method 200 optionally ends, e.g., see End. In contrast, in response to a determination that a third independent autonomous robot (which may be an independent autonomous robot of the subset of the independent autonomous robots that have a potential for losing functionality as a result of one or more of the damage events) has been damaged during the damage events, a first of the replacement independent autonomous robots is caused to be coupled within a position of the third independent autonomous robot in the snake robot, e.g., see operation 224.

A mitigating operation is, in some approaches, performed to the third independent autonomous robot in order to fix the damaged third independent autonomous robot, e.g., see operation 226. According to various approaches, the mitigating operation may include any combination of moving the third independent autonomous robot to an end tail position of the snake robot, discarding the third independent autonomous robot at a current location, causing a fourth independent autonomous robot to decouple from the snake robot to perform a fix on damaged portions of the third independent autonomous robot, etc.

In some approaches, the operations of method 200 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to determine a task and then determine independent autonomous robots that can be used to perform the task. Initial training may include reward feedback that may, in some approaches, be implemented using a subject matter expert (SME). However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some further approaches, the AI model may be a neuromyotonic AI model that may improve performance of computer devices in an infrastructure associated with independent autonomous robots, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from a customer that benefits from the task. Such an AI model ensures that determinations of which independent autonomous robots to use to complete a task are efficient, where the scale of such analysis and determinations would not otherwise be feasible for a human to perform. This is because humans are not able to efficiently perform such determinations within a time frame that tasks such as disaster recovery call, and would otherwise incorporate processing delays and errors in the determinations in the process of attempting to do so. Accordingly, management of operations described herein is not able to be achieved by human manual actions.

Several benefits are enabled using the techniques of embodiments and approaches described herein with respect to snake robots having decouplable portions that are each independent autonomous robots. For example, the flexibility and adaptability of the snake robots described herein make them particularly well-suited for navigating challenging terrains, disaster-stricken areas, confined spaces, and environments where traditional wheeled or tracked robots might struggle. Their ability to mimic the motion of real snakes enables them to access locations that might be inaccessible to other types of robots. The unique design of snake robots offers several advantages that contribute to their exceptional versatility and effectiveness in various environments. One reason a snake robot's design is advantageous is based on flexibility and maneuverability. The segmented body of a snake robot allows it to bend and twist in ways that mimic the natural motion of a snake. This flexibility enables the robot to navigate through tight spaces, cluttered environments, and complex terrains that might be inaccessible to traditional rigid robots. Furthermore, because the independent autonomous robots that make up the snake robot are able to decouple from one another, different activity subtasks are able to be concurrently performed at different locations.

The snake robots described herein are also able to adapt to different terrain by being caused to adjust shape and movement pattern to match the characteristics of the terrain that the snake robot traverses. This adaptability allows movement over rough, uneven, or irregular surfaces, including obstacles, without getting stuck. Versatile locomotion is another movement technique enabled by using the techniques described herein: The snake-like motion, such as lateral undulation and sidewinding, enables the snake robot to move efficiently on land, in water, and even through the air or space in some cases. This versatility makes the snake robot described herein suitable for a wide range of applications and environments. The snake robot described herein also offers relatively improved access when considering the deficiencies of the other conventional robots described elsewhere herein. The snake robot described herein is able to access confined or hard-to-reach spaces, such as disaster-stricken areas, rubble, pipes, and tight corners, as well as explore and gather information from such locations. This is invaluable for search and rescue missions, inspections, and exploration.

Enhanced interaction is also enabled by the techniques for determining the independent autonomous robots described herein. The smooth, slithering movement of the resulting snake robot allows the robot to be caused to interact with its surroundings more gently than traditional wheeled or tracked robots. This makes them suitable for applications where delicate handling or minimal disruption is essential. Increased stability is also enabled as a result of deploying the snake robot described herein. The multiple contact points created by the independent autonomous robots of the snake robot's body provide enhanced stability on uneven surfaces or when climbing structures. This stability improves the ability to maintain a position and avoid falls.

The snake robot described herein also offers redundancy and robustness. For example, the replacement independent autonomous robots described herein allow continued functionality despite another of the independent autonomous robots becoming damaged and/or malfunctioning. This redundancy in their design enhances the reliability and robustness of robots in challenging environments. Furthermore, a minimal footprint is used by the snake robot described herein as the snake robot can be caused to compactly coil or fold its body, reducing a footprint when not in use. This feature is advantageous in transportation, storage, and deployment scenarios. A payload of the snake robot is also adaptable as the segmented structure of the snake robot allows for the incorporation of various sensors, cameras, and tools along their length. This adaptability enables the snake robot to carry out a wide range of tasks, from inspection to data collection and manipulation. The unique design of the snake robot described herein (a plurality of independent autonomous robots) provides the snake robot with exceptional advantages in terms of mobility, adaptability, and access to challenging environments. These features make the snake robot valuable and novel tool in the technical fields such as search and rescue, exploration, inspection, and more.

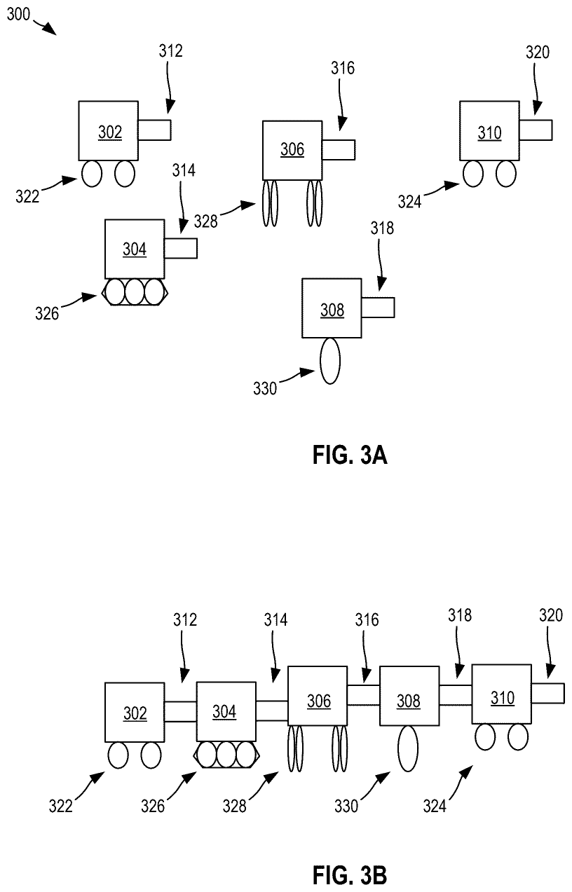

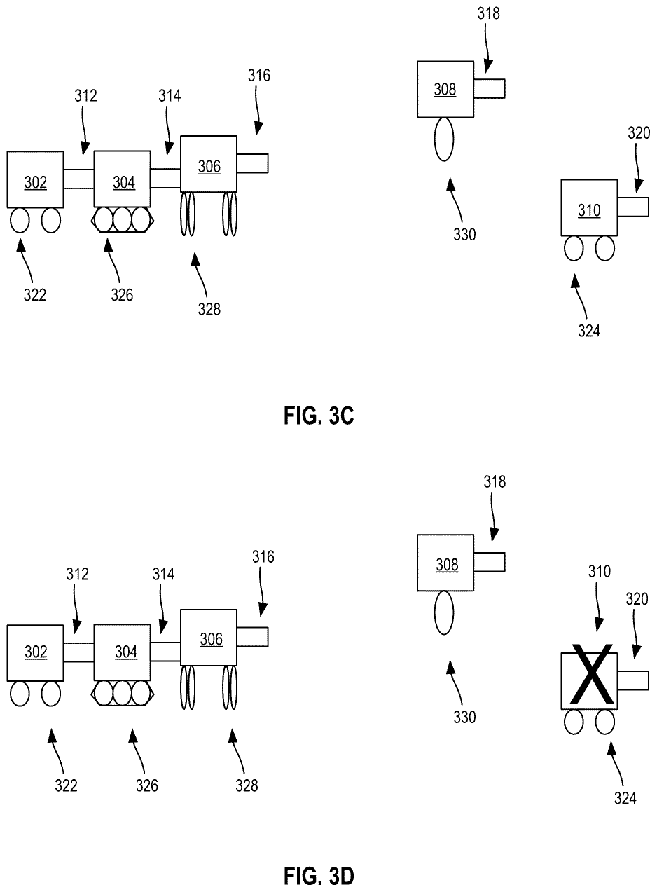

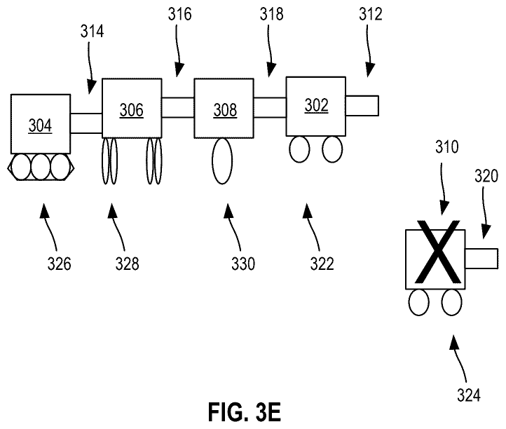

FIGS. 3A-3E depict an overview of a collection 300 of independent autonomous robots, in accordance with several embodiments. As an option, the present collection 300 may be implemented in conjunction with features from any other embodiment listed herein, such as those described with reference to the other FIGS. Of course, however, such collection 300 and others presented herein may be used in various applications and/or in permutations which may or may not be specifically described in the illustrative embodiments listed herein. Further, the collection 300 presented herein may be used in any desired environment.

Referring first to FIG. 3A, the collection 300 includes a plurality of independent autonomous robots 302, 304, 306, 308, and 310, which include selectively engaging coupling components 312, 314, 316, 318, and 320. Furthermore, the independent autonomous robots include a plurality of types of mobile components. For example, the independent autonomous robot 302 and the independent autonomous robot 310 include wheels 322 and 324, the independent autonomous robot 304 includes tracks 326, the independent autonomous robot 306 includes legs 328 and the independent autonomous robot 308 includes a propulsion engine 330.

The independent autonomous robots may be configured to perform according to a communication protocol that enables the independent autonomous robots to exchange information with each other when decoupled and/or a main body of couple independent autonomous robots (snake robot as shown in FIG. 2B). This enables synchronized and coordinated motion. An independent autonomous robot at a head position of the snake robot that is caused to compute the movement of each independent autonomous robot considering their respective capabilities such as center of gravity, power, movement gear (tracked drive, wheels, spheres, legs, etc.), type and degrees of freedom at coupling, the overall curvature to be achieved in the movement for balance of the set of ribs/segments, etc.

Furthermore, each independent autonomous robot preferably has its own control system, including sensors for environment perception (such as cameras or distance sensors) and actuators for movement (such as motors). Control algorithms allow individual independent autonomous robot to be caused to adapt their motion to the environment and contribute to the overall locomotion of the robot and will also have mobility capability. Each independent autonomous robot preferably also has a power management system that ensures each independent autonomous robot has a sustainable power source. This could involve rechargeable batteries, energy harvesting mechanisms, or a combination of both. Efficient power distribution and management are essential to maintain the autonomy of each independent autonomous robot. The independent autonomous robots also have remote control and autonomous modes for the snake robot. In autonomous mode, the independent autonomous robot are able to make decisions based on their environment and contribute to the overall movement without direct human control.

Techniques for determining which independent autonomous robot to use to perform a determined task are described elsewhere herein. In some approaches, mobility capabilities of the snake robot and the independent autonomous robots may be compared in such a determination. In response to any mobility gaps being identified (a portion of a course that will not be able to be traversed based on the current group of selected independent autonomous robots) one or more additional independent autonomous robots may be identified to be added to the plurality of independent autonomous robots. These added independent autonomous robots may be used upon reaching these portions of the course.

In some approaches, before deploying the independent autonomous robots to perform the task, a simulation of mobility between the snake robot and the independent autonomous robots in different environments may be performed. Simulations can provide insights into how the combined mobility capabilities can overcome challenges and gaps. These insights may be used to modify the independent autonomous robots that are used before deployment.

Referring now to FIG. 3B, the independent autonomous robots form segments/ribs of a snake robot by the independent autonomous robots being coupled together with the selectively engaging coupling components. These couplings align the independent autonomous robots to the previous and subsequent segments of the snake robot, which may be in a determined ordering. The independent autonomous robot at a head position of the snake robot, e.g., the independent autonomous robot 302, may at least temporarily serve as a master controller to create the snake robot structure and be caused to issue instructions to other independent autonomous robots to execute movements resembling those of a snake. As the independent autonomous robots are linked to compose the snake robot, each participating independent autonomous robot is caused to transition its computational mode to that of the snake robot from an autonomous movement control, where whole body movement is achieved by sensing and directional computation on its own. In some other approaches, movement is enabled through receipt of commands from some other controller to one where delta movement signals are received by a given independent autonomous robot from the independent autonomous robot before and after it to perform a required movement in a required time interval (while additionally and/or alternatively considering the signals from its sensors and the overall snake master control instructions).

Mobility requirements within an activity area and the number of independent autonomous robots needed for deployment in the new location may be determined. independent autonomous robot may be selected for including in the snake robot configuration up to a determined desired length of the snake robot. In some embodiments, the independent autonomous robot in the head position serves as a master controller into which the autonomous robotic systems are integrated. Subsequently, the interconnected independent autonomous robots may be caused, e.g., instructed, to transition into the computation mode suitable for the snake robot operation by running alternate segment protocols to connect with the communication, command and control structure of the independent autonomous robot in the head position of the snake robot.

In some approaches, based on a determined context of the task, e.g., the activity and/or the mobility requirements of the independent autonomous robots, operations may be performed for determining movement of the independent autonomous robots to different locations. During these movements, dynamic switching between a snake robot configuration and individual protocols of the independent autonomous robots may be initiated, e.g., such as during activity subtasks. In such instances given a final location to move to along a course that the task occurs on, a determination may be made and/or the independent autonomous robots may, in some approaches, be instructed to assess whether their autonomous mobility and sense capabilities are adequate for the task that they are to perform in the event that the independent autonomous robots need to link together to create the snake robot for improved mobility. Independent autonomous robots determined to have adequate capabilities may be set to be in the head position of a determined ordering.

In some approaches, the selectively engaging coupling components within each independent autonomous robots is equipped with mechanisms that enable the snake robot to achieve versatile movements. When the independent autonomous robots are engaged in self-mobility, the selectively engaging coupling components remain deactivated. However, when these independent autonomous robots align to form the snake robot structure, the selectively engaging coupling components are activated. This activation grants the snake robot the necessary capabilities to execute its characteristic movements.

Referring now to FIG. 3C, some of the independent autonomous robots are shown to decouple from the snake robot (be deployed) to perform portions of the activity subtask, e.g., see independent autonomous robots 308 and 310. In some approaches, the independent autonomous robots are deployed based on determined appropriate scenarios for independent autonomous robots to decouple from the snake robot. These independent autonomous robots may thereafter be recoupled with the snake robot at any time, e.g., in response to completion of the activity subtasks.

In FIG. 3D, one of the independent autonomous robots is damaged by a damage event, e.g., see independent autonomous robot 310. In response to a determination that the independent autonomous robot 310 has been damaged, a replacement independent autonomous robot may be used. In some approaches, the replacement independent autonomous robot has at least a predetermined threshold degree of similarity with capabilities of the damaged independent autonomous robot. For example, referring now to FIG. 3E, it should be noted that the independent autonomous robot 302 (which like the damaged independent autonomous robot 310 includes wheels) is caused to assume a previous position of the damaged independent autonomous robot 310 in the order of the snake robot. The damaged independent autonomous robot 310 may be discarded at a current location of the independent autonomous robot, or, in some approaches, the independent autonomous robot 310 may be coupled to the snake robot (such as in a tail position of the snake robot) and pulled back to a final destination of the snake robot.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a task to complete, wherein the task includes a mobility subtask and an activity subtask;
determining, based on the determined task, a plurality of independent autonomous robots to use to complete the task;
causing the independent autonomous robots to couple together to form a snake robot, wherein the coupling of the independent autonomous robots is established using selectively engaging coupling components of the independent autonomous robots;
causing a first of the independent autonomous robots in a head position of the snake robot to instruct a remainder of the independent autonomous robots during completion of the mobility subtask;
causing a second of the independent autonomous robots to decouple from the snake robot to perform at least a first portion of the activity subtask; and
in response to a determination that the first portion of the activity subtask has been completed by the second independent autonomous robot, causing the second independent autonomous robot to recouple with the snake robot in a determined location of the snake robot.

2. The method of claim 1, wherein the independent autonomous robots are configured to operate independently based on the independent autonomous robots including: processing circuits, mobile components, and the selectively engaging coupling components, wherein the mobile components are selected from the group consisting of: wheels, tracks, legs, water propulsion components, low gravity propulsion components, propellers, fingers, and friction components.

3. The method of claim 2, further comprising:
determining the location for the second independent autonomous robot to recouple with the snake robot, wherein the determining the location includes:
forecasting whether the mobile components of the second independent autonomous robot are needed for completing a remaining uncompleted portion of the mobility subtask; and
in response to a determination that the mobile components of the second independent autonomous robot are forecasted to be needed for completing the remaining uncompleted portion of the mobility subtask, determining and causing the second independent autonomous robot to be placed in a location within the snake robot that allows the mobile components of the second independent autonomous robot to be used for completing the remaining uncompleted portion of the mobility subtask.

4. The method of claim 1,
wherein the mobility subtask is selected from the group consisting of: climbing a structure, swimming across a body of water, navigating through and/or around a terrain obstacle, and propelling from a first location to a second location,
wherein the activity subtask is selected from the group consisting of: scanning an environment, recovering an object, carrying the object, and delivering a payload.

5. The method of claim 1, wherein the determining, based on the determined task, the plurality of independent autonomous robots to use to complete the task comprises:
identifying, over a course on which the mobility subtask is to be performed, types of mobile components that are needed to traverse the course,
wherein the plurality of independent autonomous robots are determined based on the independent autonomous robots having the identified types of mobile components.

6. The method of claim 5, further comprising:
determining a first ordering for the independent autonomous robots to be ordered in, wherein the first ordering includes the first independent autonomous robot in the head position of the snake robot,
wherein the first ordering is based on a first obstacle that the snake robot is predicted to encounter while traversing the course; and
in response to a determination that the snake robot has traversed the first obstacle, determining and reordering the independent autonomous robots in a second ordering, wherein the second ordering for the independent autonomous robots is based on a second obstacle that the snake robot is predicted to encounter while traversing the course.

7. The method of claim 5, further comprising:
forecasting, along the course, damage events;
determining a subset of the independent autonomous robots that have a potential for losing functionality as a result of one or more of the damage events,
wherein the determining, based on the determined task, the plurality of independent autonomous robots to use to complete the task comprises: adding replacement independent autonomous robots for replacing the subset of the independent autonomous robots that have a potential for losing functionality as a result of one or more of the damage events; and
in response to a determination that a third independent autonomous robot has been damaged during the damage events, causing a first of the replacement independent autonomous robots to be coupled within a position of the third independent autonomous robot in the snake robot; and
performing a mitigating operation to the third independent autonomous robot.

8. The method of claim 7, wherein the mitigating operation is selected from the group consisting of: moving the third independent autonomous robot to an end tail position of the snake robot, discarding the third independent autonomous robot at a current location, and causing a fourth independent autonomous robot to decouple from the snake robot to perform a fix on damaged portions of the third independent autonomous robot.

9. The method of claim 1, further comprising:
causing, a third of the independent autonomous robots to decouple from the snake robot to perform at least a second portion of the activity subtask,
wherein the second independent autonomous robot and the third independent autonomous robot are concurrently decoupled from the snake robot.

10. A computer program product comprising:
one or more computer readable storage media; and
program instructions stored on the one or more storage media to perform operations comprising:
determining a task to complete, wherein the task includes a mobility subtask and an activity subtask;
determining, based on the determined task, a plurality of independent autonomous robots to use to complete the task;
causing the independent autonomous robots to couple together to form a snake robot, wherein the coupling of the independent autonomous robots is established using selectively engaging coupling components of the independent autonomous robots;
causing a first of the independent autonomous robots in a head position of the snake robot to instruct a remainder of the independent autonomous robots during completion of the mobility subtask;
causing a second of the independent autonomous robots to decouple from the snake robot to perform at least a first portion of the activity subtask; and
in response to a determination that the first portion of the activity subtask has been completed by the second independent autonomous robot, causing the second independent autonomous robot to recouple with the snake robot in a determined location of the snake robot.

11. The computer program product of claim 10, wherein the independent autonomous robots are configured to operate independently based on the independent autonomous robots including: processing circuits, mobile components, and the selectively engaging coupling components, wherein the mobile components are selected from the group consisting of: wheels, tracks, legs, water propulsion components, low gravity propulsion components, propellers, fingers, and friction components.

12. The computer program product of claim 11, wherein the operations further comprise:
determining the location for the second independent autonomous robot to recouple with the snake robot, wherein the determining the location includes:
forecasting whether the mobile components of the second independent autonomous robot are needed for completing a remaining uncompleted portion of the mobility subtask; and
in response to a determination that the mobile components of the second independent autonomous robot are forecasted to be needed for completing the remaining uncompleted portion of the mobility subtask, determining and causing the second independent autonomous robot to be placed in a location within the snake robot that allows the mobile components of the second independent autonomous robot to be used for completing the remaining uncompleted portion of the mobility subtask.

13. The computer program product of claim 10,
wherein the mobility subtask is selected from the group consisting of: climbing a structure, swimming across a body of water, navigating through and/or around a terrain obstacle, and propelling from a first location to a second location,
wherein the activity subtask is selected from the group consisting of: scanning an environment, recovering an object, carrying the object, and delivering a payload.

14. The computer program product of claim 10, wherein the determining, based on the determined task, the plurality of independent autonomous robots to use to complete the task comprises:
identifying, over a course on which the mobility subtask is to be performed, types of mobile components that are needed to traverse the course,
wherein the plurality of independent autonomous robots are determined based on the independent autonomous robots having the identified types of mobile components.

15. The computer program product of claim 14, wherein the operations further comprise:
determining a first ordering for the independent autonomous robots to be ordered in, wherein the first ordering includes the first independent autonomous robot in the head position of the snake robot,
wherein the first ordering is based on a first obstacle that the snake robot is predicted to encounter while traversing the course; and
in response to a determination that the snake robot has traversed the first obstacle, determining and reordering the independent autonomous robots in a second ordering, wherein the second ordering for the independent autonomous robots is based on a second obstacle that the snake robot is predicted to encounter while traversing the course.

16. The computer program product of claim 14, wherein the operations further comprise:
forecasting, along the course, damage events;
determining a subset of the independent autonomous robots that have a potential for losing functionality as a result of one or more of the damage events,
wherein the determining, based on the determined task, the plurality of independent autonomous robots to use to complete the task comprises: adding replacement independent autonomous robots for replacing the subset of the independent autonomous robots that have a potential for losing functionality as a result of one or more of the damage events; and
in response to a determination that a third independent autonomous robot has been damaged during the damage events, causing a first of the replacement independent autonomous robots to be coupled within a position of the third independent autonomous robot in the snake robot; and
performing a mitigating operation to the third independent autonomous robot.

17. The computer program product of claim 16, wherein the mitigating operation is selected from the group consisting of: moving the third independent autonomous robot to an end tail position of the snake robot, discarding the third independent autonomous robot at a current location, and causing a fourth independent autonomous robot to decouple from the snake robot to perform a fix on damaged portions of the third independent autonomous robot.

18. The computer program product of claim 10, wherein the operations further comprise:
causing a third of the independent autonomous robots to decouple from the snake robot to perform at least a second portion of the activity subtask,
wherein the second independent autonomous robot and the third independent autonomous robot are concurrently decoupled from the snake robot.

19. A computer system comprising:
a processor set;
one or more computer readable storage media; and
program instructions stored on the one or more storage media to cause the processor set to perform operations comprising:
determining a task to complete, wherein the task includes a mobility subtask and an activity subtask;
determining, based on the determined task, a plurality of independent autonomous robots to use to complete the task;
causing the independent autonomous robots to couple together to form a snake robot, wherein the coupling of the independent autonomous robots is established using selectively engaging coupling components of the independent autonomous robots;
causing a first of the independent autonomous robots in a head position of the snake robot to instruct a remainder of the independent autonomous robots during completion of the mobility subtask;
causing a second of the independent autonomous robots to decouple from the snake robot to perform at least a first portion of the activity subtask; and
in response to a determination that the first portion of the activity subtask has been completed by the second independent autonomous robot, causing the second independent autonomous robot to recouple with the snake robot in a determined location of the snake robot.

20. The computer system of claim 19, wherein the independent autonomous robots are configured to operate independently based on the independent autonomous robots including: processing circuits, mobile components, and the selectively engaging coupling components, wherein the mobile components are selected from the group consisting of: wheels, tracks, legs, water propulsion components, low gravity propulsion components, propellers, fingers, and friction components.
